(19) United States
(12) Patent Application Publication
(10) Pub. No.: US 2021/0273905 A1
(43) Pub. Date: Sep. 2, 2021

(54) ACTIVITY AND HEALTH DATA TRIGGERED DELIVERY METHOD AND SYSTEM

(71) Applicant: HOP NGUYEN NGO, PEARLAND, TX (US)

(72) Inventor: HOP NGUYEN NGO, PEARLAND, TX (US)

(21) Appl. No.: 16/806,938

(22) Filed: Mar. 2, 2020

(51) Int. Cl. H04L 12/58; H04L 29/06; G16Y 20/40; G16Y 40/35; G16Y 20/10

(52) U.S. Cl. CPC H04L 51/36; H04L 67/42; G06Q 30/0613; G16Y 40/35; G16Y 20/10; G16Y 20/40

(57) ABSTRACT

A system and method for user-controlled and user-activated automatic delivery of physical objects and electronic messages and contents using activity and health data from a smart device is provided. The system and method includes a computer program or smart phone application to define trigger parameters for a delivery. The computer program or smart phone application obtains and analyzes data from smart devices via an application program interface. If these data match with the pre-defined trigger parameters, delivery will occur.

### FIELD OF THE INVENTION

This invention relates generally to the automatic delivery of physical objects and electronic messages and contents. More specifically, it relates to a system and method for activity and health data generated by users of a smart device to be used as triggers and patterns of triggers to activate the delivery to various types of recipients.

### BACKGROUND

Delivering purchased items, sending text messages and electronic contents such as pictures or videos, or making cell phone calls, etc. are an important part of life. However, there is a limited number of methods to control the timing of these actions. For example, sellers traditionally ship out their merchandises when buyers pay, not when buyers or recipients would like for the recipients to receive the item. In another example, users of social networking services like Facebook and Twitter have to manually input a message immediately before pressing the “send” button. These message are then immediately posted. Thus, users have to have a computer or a cell phone with them in order to pay and ship a merchandise or type and send a message. This is not practical or possible, for example, when users swim, run, drive or do daily activities that do not allow them to stop to use their computer or cell phone.

There are some sellers who let buyers specify when the merchandises are to be shipped out. There are some apps or email services that let users specify when the messages are to be sent out. However, this delay by timing is simply not useful enough because users cannot predict the best moment in the future for recipients to receive a merchandise or an email.

Smart devices can be used to improve the delivery processes above. Examples of a smart device include, but are not limited to, a wearable device such as a smart watch, etc. Users of these devices can generate a great amount of data which are currently used only for sport activity and health. These data have only been used mostly as a notification of speed, distance, heart rate, etc. due to the limited software and hardware environments designed by a particular manufacturer. For example, Garmin smart watches allow users to set different heart rate ranges but users can only choose one particular range at a time for the watch to send out-of-range notifications. Therefore, the limited number of notifications from a smart watch or similar devices results in limited and inflexible functions. For example, a runner's out-of-range heart rates can only be delivered to his or her coach by one independent measurement at a time without showing a trend or pattern.

These notifications and the entire activity and health data should be collected and analyzed by a separate system in order to be more useful in other purposes such as delivery. What is needed is a user-controlled and user-activated system and method with an unlimited number of trigger mechanisms, using activity and health data generated by users of smart devices, to automatically generate a delivery of physical objects and electronic messages and contents to recipients such as persons, physical addresses, email addresses, individual accounts on social networking services, etc.

### BRIEF DESCRIPTION OF THE FIGURES

The following figures illustrate the present invention. These figures, together with the description, explain the principles of the invention and enable a person skilled in the art to understand and use the invention.

FIG. 1 is a diagram of an exemplary operating environment for a system and method for user-controlled and user-activated automatic delivery of physical objects and electronic messages and contents via triggers from smart devices.

FIG. 2 is a flowchart of the system and method for user-controlled and user-activated automatic delivery of physical objects and electronic messages and contents via triggers from smart devices.

The present invention will now be described with reference to the accompanying figures. In the figures, similar reference numbers can indicate identical of functionally similar elements.

### DETAILED DESCRIPTION OF THE INVENTION

The method and system for user-controlled and user-activated automatic delivery of physical objects and electronic messages and contents via activity and health data is herein described. Examples of electronic messages and contents include, but are not limited to, voice recordings, pictures, videos, word documents, PFD files, multimedia, etc. Users of smart devices generate activity and health data which are obtained via an application programming interface from the device manufacturer, then analyzed and stored by the method and system. Users of the method and system select one or more of physical objects and/or electronic messages and contents, one or more recipients and schedule a delivery by defining trigger parameter's composed of the activity and health data. The method and system then stores the trigger parameters coupled with physical objects and electronic messages and contents and recipients. The method and system then waits for, receives and analyzes new activity and health data. If the new data match with the pre-defined parameters, the method and system will activate the delivery. Users of the smart devices, via this trigger mechanism, can, but is not required to, take any explicit action to activate the delivery. Users can actively control and activate a delivery by physically pressing the control buttons of the smart devices to generate activity and health data. Users can also actively control and activate a delivery by intentionally generating and matching their own activity and health data to the stored pre-defined trigger parameters. A delivery can also be activated by activity and health data unintentionally generated by users while performing the activity. Alternatively, users can use other users' activity and health data for the same processes above.

### 1. Structural Embodiment

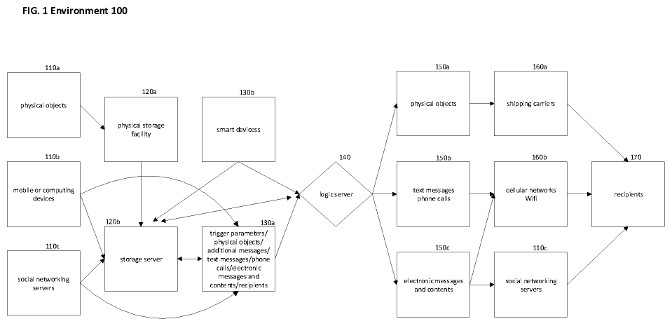

FIG. 1 is a diagram of an exemplary operating environment 100 for the system and method of automatic delivery of physical objects and electronic messages and contents. Operating environment 100 includes one or more owners of physical objects 110a, one or more mobile or computing devices 110b, one or more social networking servers 110c, one or more physical storage facility 120a, one or more storage servers 120b, one or more user-defined trigger parameters 130a, one or more smart device triggers 130b, one or more logic servers 140, one or more physical objects 150a to be sent via shipping carriers 160a, one or more text messages and phone calls 150b and electronic messages and contents 150c to be sent via WiFi or cellular networks 160b, and finally, one or more recipients 170. The one or more electronic messages and contents 150c can also be sent via one or more social networking servers 110c to one or more recipients 170.

Owners of physical objects (e.g., an heirloom) 110a store these objects in the physical storage facility 120a. Physical objects are electronically tagged with new names and stored in the storage server 120b. Mobile or computing devices (e.g., smart phones, computers, tablets) 110b are configured to create, retrieve and transfer electronic messages and contents (e.g., pictures, videos, documents) to the storage server 120b. These electronic messages and contents can be stored in the storage server 120b as untagged or tagged with new names. Social networking servers (e.g., Facebook, Instagram) 110c are configured to transfer electronic messages and contents to the storage server 120b. These electronic messages and contents can also be stored in the storage server 120b as untagged or tagged with new names. Electronic messages and contents from mobile or computing devices and social networking servers can also be attached to one or more trigger parameters 130a prior to being stored in the storage server 120b as untagged or tagged. User-defined trigger parameters 130a are attached to physical objects, additional written messages, text messages, phone calls, electronic messages and contents and one or more recipients. Again, materials that come from mobile or computing devices 110b and social networking servers 110c can be attached directly from these devices or servers to one or more trigger parameters 130a. Alternatively, these materials can be stored in the storage server 120b from which they can be retrieved and attached to one or more trigger parameters 130a. Thus, in this method, materials from any sources can be attached to one or more trigger parameters 130a. Smart device data 130b come from devices that measure, collect and transmit activity and health data while remaining in close proximity with a user (e.g., smart running watch, smart bottle, smart stationary bike). Smart device data 130b can be stored in the storage server 120b and used later to activate the trigger parameters 130a. The user-defined trigger parameters/physical objects/electronic messages and contents/recipients and the smart device data combinations are stored in the storage server 120b. The logic server 140 receives the smart device data that come from the storage server 120b or directly from the smart devices, or from both, and analyzes for an indication that a user-defined trigger parameter has been met. If the parameter has not been met, the combinations remain in the storage server 120b and wait for the next smart device data. If the parameter has been met, automatic delivery will occur. Please note that some steps in FIG. 1 do not have to occur in any particular order or sequence as discussed in this or the previous paragraphs.

Delivery includes but is not limited to the following materials or scenarios. Physical objects 150a are sent via shipping carriers 160a (e.g., UPS, FedEx, USPS) to recipients 170 (e.g., a physical address). Text messages including pictures, videos, etc. and phone calls 150b are transmitted via WiFi or cellular networks 160b to recipients 170 (e.g., a cell phone, a computing device), Electronic messages and contents 150c (e.g., pictures, videos, written messages, voice recordings) are sent to social networking servers 110c (e.g., Facebook, Twitter) which then post these messages and contents to the recipients 170 which are the associated Facebook or Twitter accounts. Electronic messages and contents are also transmitted via WiFi or cellular networks 160b to recipients 170. Please note that any or all of the above delivery examples can take place depending of the pre-defined trigger parameters and the attached materials to be delivered.

### 2. Operational Embodiments

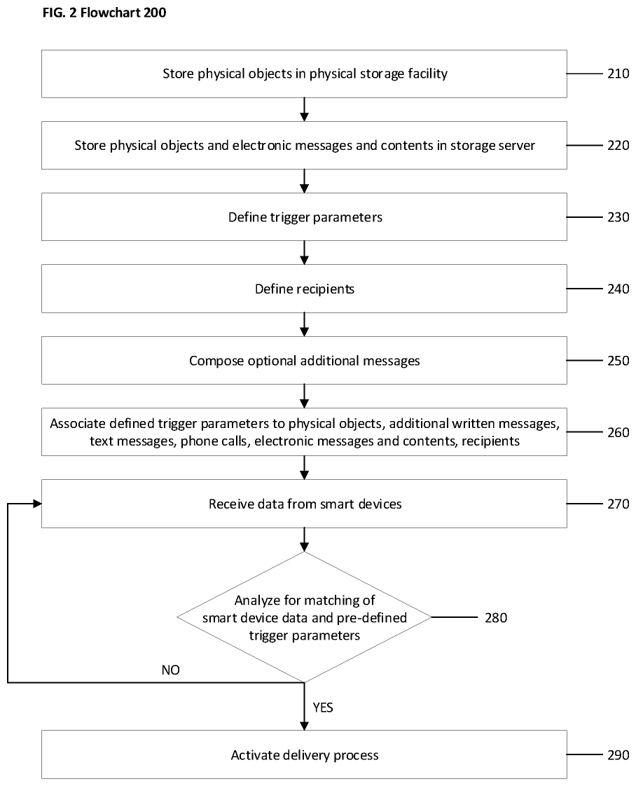

FIG. 2 depicts a flowchart 200 of the method for automatic delivery as described in this present invention. Flowchart 200 will be described with continued reference to the operating environment 100 in FIG. 1. Please note that some steps in FIG. 2 do not have to occur in any particular order as discussed.

Prior to a user accessing the method for automatic delivery, the application or software for this method needs to be downloaded and installed to networking devices including, but not limited to, cell phones, tablets, computers, laptops, etc. Also, users of social networking services need to grant this method access to their email, social media accounts, etc. Access is required to retrieve contents as well as to post contents into the account servers which then post the contents onto the individual accounts, pages, walls, folders, etc.

In step 210, the method and system receives, tags and stores physical objects in the physical storage facility 120a. In step 220, the system and method tags and stores physical objects and electronic messages and contents in the storage server 120b. Electronic messages and contents may come from a storage location such as the camera roll of a mobile device or a folder of a computing device 110b or may come from social networking servers 110c. In step 230, users define trigger parameters. In step 240, users define recipients. In step 250, users have an option to compose an additional electronic message. In step 260, users associate trigger parameters to recipients, additional electronic messages, physical objects and/or electronic messages and contents previously stored in the storage server 120b. Alternatively, in step 260, users can associate trigger parameters to recipients, additional electronic messages, physical objects and/or electronic messages and contents transferred directly from mobile or computing devices 110b and social networking servers 110c. These directly-transferred electronic messages and contents will be stored in the storage server 120b upon being associated with a trigger parameter. The combined trigger parameters/recipients/additional electronic messages/physical objects and/or electronic messages and contents are then stored in the storage server 120b. In step 270, the system and method receives and stores activity and health data from smart devices 130b. Note that these data concurrently go to the storage server 120b for storage purpose and to the logic server 140 for analysis purpose. In step 260, the logic server 140 analyzes for an occurrence of smart data matching a pre-defined parameter using newly received smart data and, if needed, using previously received and stored smart data. The need for previously received and stored smart data depends on the type of triggers and patterns of triggers. If the smart data do not match a trigger parameter, the logic server 140 will wait for the next smart data. If the smart data match a trigger parameter, the logic server 140 will activate the delivery process. In step 290, the logic server 140 will deliver to recipients 170 according to environment 100. More specifically, physical objects 150a will be delivered via a shipping carrier 160a to recipients 170 which in this case can be a home address. Also, text messages and phone calls 150b will be delivered via WiFi or a cellular network 160b to recipients 170 which in this case can be a cell phone or a computer. Additionally, electronic messages and contents such as emails, pictures, videos, messages to be posted on social media, etc. 150c will be delivered via social networking servers 110c or via a cellular network 160b to recipients 170 which in this case can be an email address, a social media account such as Facebook, Twitter, etc. Again, please note that any or all of the above delivery examples can take place depending of the pre-defined trigger parameters and the attached materials to be delivered.

1. A system and method for user-controlled and user-activated automatic delivery of physical objects and electronic messages and contents via activity and health data from smart devices, hereinafter referred as “the method”, the method including:
a. providing a user application interface for user to:
document and store physical objects in a physical holding facility; or save electronic messages and electronic contents (e.g., voice recordings, pictures, videos, word documents, PFD files, multimedia) in the server of the method; the electronic contents can be imported directly from social media server or from user device, or can be captured with user device camera immediately prior to being imported, etc.;
tag physical objects and electronic contents with new names and display these names and provide a search function to search for these names;
select an activity and select one or more individuals who generate activity and health data during this activity; activity data include but are not limited to speed, distance, pace, etc.; health data include but are not limited to heart rate, temperature, weight, etc.;
select one or more triggers or patterns of triggers, the selected triggers comprising of activity and health data automatically recorded by a smart device, transferred to the device server and then transferred to the storage server and logic server of the method;
select an optional delay and a duration of the delay of the one or more triggers or pattern of triggers relative to the activity start time;
select a duration and frequency of the one or more triggers or patterns of triggers;
select a one or more physical objects and/or customize one or more electronic messages and attach one or more electronic contents from one or more sources (e.g., user device, the method server, social media server);
select a method of delivery for physical objects (e.g., by truck, by airplane) or select a method of delivery for electronic messages and contents (e.g., text, phone call, email, posting on social media);
select one or more recipients to which the physical objects, electronic messages and contents are to be delivered; the recipients comprising of, but not limited to, a physical address, a person, a smart phone capable of receiving a phone call or a message, a traditional network communication system (e.g., email), an online platform (e.g., publicly accessible website, blog), an instant messaging application (e.g., Messenger, Whatsapp) or a social media platform (e.g., Twitter, Facebook, Instagram, YouTube) which forwards the electronic contents to and posts on the individual account associated with the user on the platform, etc.;
b. storing the predefined triggers, patterns of triggers and electronic messages and contents in the storage server of the method;
c. receiving data from a smart device application interface by the logic server of the method, the logic server matching the incoming data with the stored and pre-defined triggers and patterns of triggers and analyzing for an occurrence of a predefined triggers and pattern of triggers;
d. automatically initiating the process of delivering physical objects and electronic messages and contents to recipients;

2. The method of claim 1, wherein smart devices are devices that can measure, collect and transmit activity and health data while remaining in close proximity with a user. These device can be unportable or portable. Unportable devices are devices that are too heavy or bulky to move or are designed to be stationary. Examples of unportable smart devices include, but are not limited to, a Peloton or an Echelon stationary bicycle. Portable devices are devices that can be easily carried by users or move with users. These devices remain attached to or stay on or in the user's body during an activity or permanently. Examples of a smart portable smart device include, but are not limited to, hand-held devices, implantable devices, wearable devices, fitness trackers, smart watches, smart jewelry, smart clothing, smart shoes or head mounted displays such as smart glasses (e.g., Apple watches, Clim8 smart shirts, FeetMe smart shoes, Google glasses, Garmin power meter pedals on a bicycle, etc). Another example is the H2Opal smart bottle that measures when and how much fluid a person drinks. These bottles can be carried by the user on the shoulder or inside a backpack or a cooler. Another example is the Withings smart scale that monitors weight. Another example is the Fever Scout Wearable Thermometer. Another example is a pace-maker;

3. The method of claim 1, wherein a smart device automatically records and sends data to the device server; these data are then automatically transmitted to the server of the method of claim 1 via an application programmable interface;

4. The method of claim 1, wherein the method grants users direct access to a third party app to directly view electronic contents and import electronic contents to the method server or to attach electronic contents to a trigger to be delivered via a trigger mechanism;

5. The method of claim 1, wherein users can tag an electronic content with new names and display these names while viewing this content or while setting the trigger and attaching this content;

6. The method of claim 1, wherein an activity can include, but is not limited to, a practice, a competition, a performance, a participation of an audience, a daily activity, etc. by one or more individuals;

7. The method of claim 1, wherein an individual includes, but is not limited to, a person, an animal, a robot or a machine, etc. capable of generating data;

8. The method of claim 1, using a smart watch as an example for claims 8 to 18, wherein activity and health triggers are non-specific and specific triggers. An example of a non-specific trigger is any non-specified distance run by a runner that is higher than a defined distance goal (e.g., if the runner defines a distance of 10 miles and a trigger of any distance longer than 10 miles, the trigger will be activated after the runner runs any distance longer than 10 miles such as 10.1 miles, 10.5 miles, 11 miles, etc.). An example of a specific trigger is a specified distance run by a runner that is higher than a defined distance goal (e.g., if the runner defines a goal of 10 miles and a specific trigger of exactly 11 miles, the trigger will not be activated after the runner runs 10 miles but will only be activated when the runner reaches the 11 mile mark);

9. The method of claim 1, wherein activity and health patterns of triggers are non-specific and specific triggers. An example of a non-specific pattern of trigger is a non-specified set of three consecutive heart rate notifications of a runner that are higher than the defined heart rate zone (hereinafter, in beats per minute) (e.g., if the runner defines a heart rate zone of 170 to 180, the pattern of trigger will be activated by any 3 consecutive heart rate notifications higher than 180 such as 185/195/190, 200/195/181, 181/182/183, etc.). An example of a specific pattern of trigger is a specified set of three consecutive heart rate notifications of a runner that are higher than the defined heart rate zone (e.g., if the runner defines a heart rate zone of 170 to 180 and specific pattern of trigger at 190/192/194, the pattern of trigger will only be activated by 3 consecutive heart rate notifications of 190/192/194);

10. The method of claim 1, wherein triggers and patterns of trigger can be set within a duration a one-time activity (e.g., one run) or based on the same type of activity that takes place over different times (e.g., for a 3-day run training regimen, triggers a re max heart rate at 190 on day 1, max heart rate at 195 on day 2 and max heart rate at 200 on day 3);

11. The method of claim 1, wherein triggers and patterns of trigger can be set based on different types of activity that take place over different times or stages (e.g., for a multi-sport regimen such as an ironman, triggers a re max heart rate at 190 for the swim part, max heart rate at 195 for the bike part and max heart rate at 200 for the run part);

12. The method of claim 1, wherein triggers and patterns of triggers can be set with a delay relative to the start of an activity or an event (e.g., a trigger only becomes active after the first 20 miles of a marathon or, in another example, a trigger only becomes active after the first 2 hours of a marathon). In this case, the triggers and patterns of triggers only become active and still need to wait for data to be activated and to start a delivery process;

13. The method of claim 12, wherein triggers and patterns of triggers can be set to become active automatically when the start of the event is known (e.g., a user knows the start time of a marathon and sets the activated time to be 2 hours after the start);

14. The method of claim 12, wherein triggers and patterns of triggers can be set to become active by manual input from the account owner or the account owner's authorized users when the start of the event is unknown (e.g., a person doesn't know when exactly he will fall into deep sleep). In this case, the account owners themselves or the account owners' authorized users manually indicate in the method that the start of an activity or an event has begun (i.e., the authorized users manually input the time the user falls into deep sleep);

15. The method of claim 1, wherein users can set a duration of time during which a trigger or pattern of triggers occurs (e.g., a single trigger with a constant heart rate measurement of 180 within a 30-second time frame or a set of three decreasing heart rate measurements of 180/150/130 within a 30-second duration);

16. The method of claim 1, wherein users can set a frequency and the number of times to detect a trigger or pattern of triggers (e.g., a pattern of triggers with a set of 3 specific heart rates to be measured every 2 minutes for 10 times);

17. The method of claim 1, wherein users can set a specific or non-specific pattern of triggers that includes measurements above, below or both above and below a zone (e.g., fora heart rate zone of 170-180, a specific pattern of triggers is the 3 heart rate measurements of 170/170/170, and a non-specific pattern of triggers is the heart rate measurements of above/above/below the defined heart rate zone: 181 or higher/181 or higher/170 or lower);

18. The method of claim 1, wherein users can set a combination of similar types of triggers or patterns of triggers (e.g., for the same heart rate zone of 170 to 180, trigger #1 is set at 171, trigger #2 is set at 179 and trigger #3 is set as a pattern of 170/175/180);

19. The method of claim 1, wherein users can set a combination of different types of triggers or patterns of triggers (e.g., a specific pattern of triggers of 3 heart rate measurements of 190/190/110 only when the pace is 10 min/mile or faster);

20. The method of claims 8 through 17, wherein users can set a single trigger, a single pattern of triggers or any combination of triggers and patterns of triggers from one or different types of activity and health data (e.g., a specific pattern of triggers of 3 heart rate measurements of 190/190/110 only when temperature is above 90° F.);

21. The method of claims 8 to 18, wherein triggers and patterns of triggers can be set with other smart devices instead of with a smart watch. An example of other smart devices is a smart bottle made by H2Opal, Hidrate Spark 3 or Ozmo, etc., which measures the amount of fluid consumption. For a 16 ounce bottle, a zone from 1 to 2 ounce of water present in the bottle can be set and similar triggers and patterns of triggers can be set as mentioned in the example of a smart watch from claims 8 to 18;

22. The method of claim 1, wherein triggers and patterns of triggers can be set based on the ratio of activity and health data obtained from the same device or the same type of smart device (e.g., the ratio of speed vs heart rate as a trigger, with both speed and heart rate data obtained from a smart watch);

23. The method of claim 1, wherein triggers and patterns of triggers can be set based on the ratio of activity and health data obtained from different types of smart devices (e.g., the ratio of speed vs the amount of water consumed as a trigger, with speed data obtained from a smart watch and amount of water consumed obtained from a smart bottle);

24. The method of claim 1, wherein users have an option to specify one or multiple recipients to receive a delivery such as an email;

25. The method of claim 19, wherein, in the case of multiple email recipients, users have an option to specify if all recipients can see and reply to the sender and everyone else or if each recipient is the sole recipient of the email and can only reply to the sender;

26. The method of claim 1, wherein users have an option to specify one or multiple social media platforms (e.g., Facebook, Twitter, Instagram, etc.) to concurrently post messages and additional contents based on the same triggers or patterns of triggers;

27. The method of claim 1, wherein a set of triggers and patterns of triggers can be set for different delivery options based upon the result of different sets of triggers and patterns of triggers. For example, a message is set to be sent to a recipient when heart rate reaches above a certain heart rate zone at a temperature below 70° F. and a different message is set to be sent to the same recipient when heart rate reaches above the same heart rate zone at a temperature above 90° F.;

28. The method of claim 1, wherein activity and health data can be generated by an affirmative user action or by a passive user action. An affirmative user action, in order to generate a trigger, involves users physically touching a button, a screen, etc. of a smart device or verbally directing a voice-controlled intelligent personal assistant service such as Alexa. An example of an affirmative user action is the act of a marathon runner pressing the stop button of a triathlon while crossing the finishing line to indicate the end of the marathon (i.e., pressing the button by user generates the trigger). A passive user action involves no direct explicit user action with the device in order to generate a trigger. In this case, users simply wear a device such as a smart watch, carry a device around such as a smart bottle, ride a stationary device such as a smart bike, etc. An example of a passive user action is a person running of the marathon until the watch records the distance of 26.2 miles (i.e., distance automatically recorded by the watch is the trigger);

29. The method of claim 26, in the case of a passive user action, wherein users can intentionally (i.e., knowingly) or unintentionally (i.e., unknowingly) generate activity and health data to match with pre-defined triggers and patterns of triggers. In an example of intentionally generated data, a runner pre-defines a pattern of “below-above-below a heart rate zone within a 10-second period”, then intentionally runs very slow, then very fast, then very slow again in order to generate the data within a 10-second period to match the pattern. In an example of unintentionally generated data, the runner simply runs and when the watch records the previously described pattern without the user being aware of generating that pattern, the system and method will record that a matching of data vs pre-defined pattern of triggers has occurred;

30. The method of claim 1, where in users of the method can use activity and health data generated by themselves or by others.
